(19) United States
(12) Patent Application Publication
(10) Pub. No.: US 2017/0338487 A1
(43) Pub. Date: Nov. 23, 2017

(54) METHOD FOR PRODUCING A CATHODE MATERIAL AND SPECIAL CATHODE MATERIAL

(71) Applicant: Evonik Degussa GmbH, Essen (DE)

(72) Inventors: Stipan KATUSIC, Bad Soden (DE); Peter KRESS, Karlstein (DE); Michael HAGEMANN, Kahl (DE); Armin WIEGAND, Grosskrotzenburg (DE)

(73) Assignee: Evonik Degussa GmbH, Essen (DE)

(21) Appl. No.: 15/529,207

(22) PCT Filed: Nov. 12, 2015
(86) PCT No.: PCT/EP2015/076430

§ 371 Date: May 24, 2017

(30) Foreign Application Priority Data
Nov. 25, 2014 (EP) 14194628.5

(51) Int. Cl. H01M 4/525; C01G 53/00; H01M 4/505; H01M 10/0525; H01M 4/02

(52) U.S. Cl. CPC H01M 4/525; H01M 4/505; H01M 10/0525; C01G 53/50; C01P 2002/50; C01P 2002/85; H01M 2004/028; C01P 2006/42

(57) ABSTRACT

A pulverulent cathode material contains at least one mixed oxide containing the metal components Li, at least one further metal component selected from the group consisting of Mn, Ni and Co. The pulverulent cathode material is produced by a process in which an ammonia-containing aerosol containing metal compound of the metal components is converted in a high-temperature zone of a reaction space and then the solids are removed.

The invention relates to a process for producing cathode materials for lithium ion batteries by means of a spray pyrolysis process, and to specific cathode materials themselves.

EP-A-814524 discloses a spray pyrolysis process for preparation of a mixed lithium-manganese oxide, in which lithium salts and manganese salts, dissolved in a water/alcohol mixture, are atomized, the resultant aerosol is pyrolysed in the presence of oxygen by means of external heating at 400 to 900° C., and the reaction product obtained is subsequently subjected to thermal treatment in order to obtain a mixed lithium-manganese oxide having a mean particle diameter between 1 and 5 μm and a specific surface area between 2 and 10 m²/g.

EP-A-824087 discloses an analogous process for preparing mixed lithium-nickel oxides or mixed lithium-cobalt oxides.

EP-A-876997 additionally discloses that preparation of these mixed oxides is accomplished using compounds such as hydrogen peroxide or nitric acid which afford oxygen on pyrolysis.

A disadvantage in the processes disclosed in EP-A-814524, EP-A-824087 and EP-A-876997 is the thermophoresis which is observed in many high-temperature operations, with formation of a wall covering which reduces the amount of energy introduced.

WO2012/018863 discloses a process in which a solution comprising a lithium salt and a metal salt having Ni, Co, Mn, Al, Mg, Fe, Cu, Zn, V, Mo, Nb, Cr, Si, Ti, Zr as metal is converted to an aerosol by spraying and the latter is introduced into a pyrolysis flame. Predominantly spherical particles are obtained. A disadvantage in this process has been found to be that the metal components are not distributed homogeneously.

Taniguchi et al. (Journal of Power Sources 109 (2002) 333-339) disclose a spray pyrolysis process for preparation of a mixed lithium oxide of the composition LiM_{1/6}Mn_{11/6}O₄ (M=Mn, Co, Al and Ni), in which an ultrasound atomizer is used for atomization of a solution of the nitrates in water, 0.45 mol/I. The temperature is provided by an electrically heated reactor. An ultrasound atomizer is likewise used by Ogihara et al. (Transactions of the Materials Research Society of Japan 32 (2007) 717-720) in the spray pyrolysis for preparation of Li[Ni_{1/3}Mn_{1/3}Co_{1/3}]O₂.

The preparation of the latter mixed oxide via spray pyrolysis is also described by Kang et al. (Ceramics International 33 (2007) 1093-1098). This involves using solutions of the nitrates or acetates of nickel, cobalt and manganese, and also lithium carbonates. By a similar process, Kang et al. (Journal of Power Sources 178 (2008) 387-392) describe the preparation of LiNi_{0.8}Co_{1.15}Mn_{0.05}O₂.

Pratsinis et al. (Materials Chemistry and Physics 101 (2007) 372-378) describe a spray pyrolysis process for preparation of LiMn₂O₄, Li₄Ti₅O₁₂ and LiFe₅O₈. This involves using lithium t-butoxide and manganese acetylacetonate or manganese 2-ethylhexanoate, lithium t-butoxide and titanium isopropoxide, and lithium t-butoxide and iron naphthenate. A similar process is described by Pratsinis et al. in Journal of Power Sources 189 (2009) 149-154, in which the acetylacetonates of lithium and manganese are dissolved in a solvent mixture of 2-ethylhexanoic acid and acetonitrile.

Disadvantages of the spray pyrolysis processes disclosed in the journal literature are the low throughputs thereof, such that implementation on the industrial scale is uneconomic. Moreover, these arrangements are unsuitable for scale-up of the processes to higher throughputs.

Axelbaum et al. disclose, in Journal of Power Sources 266 (2014) 175-178, a flame spray pyrolysis process for preparation of Li_{1.2}Mn_{0.54}Ni_{0.13}Co_{0.13}, with which the formation of hollow spheres can be avoided. For this purpose, it is necessary to grind the material in the presence of a solvent after a first flame spray pyrolysis, and to pyrolyse the resulting dispersion again.

The technical problem addressed by the present invention was that of providing a process which can be performed on the industrial scale and in which a cathode material having high capacity is formed. The invention further provides cathode material having high capacity.

The invention provides a process for producing a pulverulent cathode material comprising at least one mixed oxide containing the metal components Li, at least one further metal component selected from the group consisting of Mn, Ni and Co, in which an ammonia-containing aerosol containing metal compounds of the metal components is converted in a high-temperature zone of a reaction space and then the solids are removed.

Preferably, the aerosol is obtained by atomizing a solution containing the metal compounds by means of an atomization gas. The atomization is best effected by means of a one-phase or multiphase nozzle, the mean droplet diameter of the aerosol being not more than 100 μm, preferably 30 to 100 μm.

The concentration of ammonia is preferably 0.5-5.0 kg NH3/kg of the metals used, more preferably 0.8-2.8 kg/kg. Within these ranges, the influence on the homogeneity of the metal oxide particles to be produced is at its greatest.

In a preferred embodiment, the high-temperature zone into which the mixture is introduced is a flame which is formed by the reaction of an oxygen-containing gas and a combustion gas, preferably combustion gas which forms water in the reaction with oxygen.

The combustion gas used may be hydrogen, methane, ethane, propane, butane and mixtures thereof. Preference is given to using hydrogen.

The oxygen-containing gas is generally air. In the process according to the invention, the amount of oxygen should be chosen so as to be sufficient at least for complete conversion of the combustion gas and of all the metal compounds. It is generally advantageous to use an excess of oxygen. This excess is appropriately expressed as the ratio of oxygen present/oxygen required for combustion of the combustion gas and is identified as lambda. Lambda is preferably 1.1 to 6.0, more preferably 2.0 to 4.0.

A specific embodiment of the invention envisages that, for the ratio of mean velocity of the mixture to mean velocity of the flame, 2≦Vₐₑᵣₒₛₒₗ/V_{flame}≦10. Within this range, a particularly homogeneous distribution of the components of the cathode material is found.

The process according to the invention also allows the production of a doped cathode material. A prerequisite is that the solution contains at least one dopant compound containing a metal selected from the group consisting of Ag, Al, B, Ca, Cr, Cu, Fe, Ga, Ge, In, K, Mg, Mo, Na, Nb, Si, Sn, Ta, Ti, Tl, V and Zr. A particularly preferred metal is Al. The dopant compound is preferably used in such an amount that the later cathode material contains not more than 10% by weight of dopant component, more preferably 0.1% to 5% by weight.

It is advantageous for the present invention when the metal compounds are present in a solution. In order to achieve solubility and in order to attain a suitable viscosity for the atomization of the solution, the solution can be heated. In principle, it is possible to use all soluble metal compounds which are oxidizable. These may be inorganic metal compounds, such as nitrates, chlorides, bromides, or organic metal compounds, such as alkoxides or carboxylates. The alkoxides used may preferably be ethoxides, n-propoxides, isopropoxides, n-butoxides and/or tert-butoxides. The carboxylates used may be the compounds based on acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid and/or lauric acid. In a preferred embodiment, at least one metal nitrate is used.

The solvent may preferably be selected from the group consisting of water, C₅-C₂₀-alkanes, C₁-C₁₅-alkanecarboxylic acids and/or C₁-C₁₅-alkanols. More preferably, it is possible to use water or a mixture of water and an organic solvent. Organic solvents used, or constituents used in mixtures of organic solvents, may preferably be alcohols such as methanol, ethanol, n-propanol, isopropanol, n-butanol or tert-butanol, diols such as ethanediol, pentanediol, 2-methylpentane-2,4-diol, C₁-C₁₂-carboxylic acids, for example acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid, lauric acid. It is additionally possible to use benzene, toluene, naphtha and/or benzine. Preference is given to using an aqueous solvent.

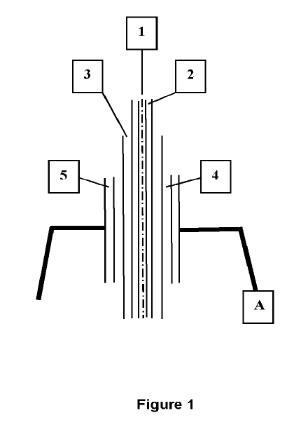

FIG. 1 shows a schematic of a possible arrangement for introduction of the feedstocks into the reaction space, where: 1=solution containing metal compounds, 2=atomizing gas, 3=ammonia, 4=air, 5=combustion gas, A=reaction chamber wall.

A further embodiment of the invention envisages that the solids removed are subjected to thermal treatment at temperatures of 850 to 1000° C. over a period of 2 to 36 h. The treatment can be effected in the presence of air or oxygen-enriched air, corresponding to an oxygen content of 21%-40% by volume. Treatment in oxygen-enriched air gives the best results.

The invention further provides a pulverulent cathode material in the form of aggregated primary particles, comprising a mixed oxide powder having a composition corresponding to Li₁₊ₓ(NiₐCo_{b}Mn_{c})D_{d}O₂, and H and N as non-metal components, with

a proportion of H of 0.01%-0.1% by weight and
a proportion of N of 0.002%-0.05% by weight, based in each case on the pulverulent cathode material, where D=Ag, Al, B, Ca, Cr, Cu, Fe, Ga, Ge, In, K, Mg, Mo, Na, Nb, Si, Sn, Ta, Ti, Tl, V and Zr, and 0<x≦0.2; 0<a≦1; 0≦b≦1; 0≦c≦1, 0≦d≦0.2.

Preferably, 0<x≦0.2, 0.1≦a≦0.2; 0.05≦b≦0.2; 0.5<c≦0.6 and d=0 or 0<x≦0.2; 0<a≦1; b=0; 0.5<c≦0.6 and 0.05<d≦0.1.

Primary particles are the smallest particles that are not divisible any further and are detectable, for example, by means of transmission electron microscopy (TEM). The mean primary particle diameter can be determined, for example, by counting the particles in TEM images. Several primary particles join together firmly at their contact sites to form aggregates. The aggregate dimensions can be determined, for example, by laser diffractometry. The cathode material according to the invention, after an optional heat treatment, has a mean particle size of 1 to 10 μm.

In a specific embodiment, it is a feature of the pulverulent cathode material according to the invention that the mean relative concentration of the elements Ni, Mn and Co, which is determined by means of TEM-EDX from 18 randomly selected regions each comprising a volume of about 500 nm³ of the cathode material, does not deviate by more than 5% from the concentration of the pulverulent cathode material determined by means of ICP-OES, inductively coupled plasma optical emission spectrometry.

In a specific embodiment, it is a feature of the pulverulent cathode material according to the invention that the standard deviation in the relative concentration of the elements Ni, Mn and Co, which is determined by means of TEM-EDX from 18 randomly selected regions each comprising a volume of about 500 nm³ of the cathode material, is not more than 5% per element.

The invention further provides for the use of the pulverulent cathode material according to the invention as a constituent of lithium ion batteries.

### EXAMPLES

Analysis

TEM-EDX: The samples are each analysed at 18 different, representative sites by means of the EDX analysis. The volume analysed is about 500 nm³ per measurement point. The analyses were conducted with a Jeol 2010F transmission electron microscope at acceleration voltage 200 kV and a Noran EDX analysis with the NSS 3.1 evaluation software.

ICP-OES: The metal concentrations were determined by means of ICP-OES. The samples were analysed with the PerkinElmer Optima ICP-OES system. The relative uncertainty in the results for the metals is 0.5%-2%.

H, N: The hydrogen and nitrogen content is determined by means of the LECO TCH600 elemental analyser. The uncertainty in the results is 0.8%-1.0%.

BET: The BET surface area is determined to DIN ISO 9277.

Electrochemical characterization: The cathode materials are incorporated into a customary standard slurry. The proportion by mass of the cathode material in the slurry is 32.7% by weight. Subsequently, the electrochemical cells produced are cycled between 2.0 and 4.6 V at 25° C. The charging and discharging currents are fixed at 25 mAh/g of cathode material.

Solutions used: For Examples 1 to 6, a solution comprising the salts specified in Table 1 is prepared in each case with water as solvent. An aerosol is produced from the solution and atomizer air by means of a nozzle and is atomized into a reaction space. The aerosol is reacted in a hydrogen/air flame which burns here. After cooling, the cathode material is separated from gaseous substances at a filter. The solid product is heated to a temperature of 875 to 1000° C. in a rotary tube oven within 3 to 10 hours. Subsequently, it is kept at this temperature over a period of 4 to 10 hours and subsequently cooled to room temperature over a period of about 12 hours.

Table 1 gives all the relevant parameters for preparation of the cathode material and important physical properties of the powders obtained, along with their electrochemical properties.

Table 2 shows the homogeneous distribution of a comparative material which has been produced without ammonia, with a cathode material produced by the process according to the invention.

TABLE 1
Preparation of Li₁₊ₓ(NiₐCo_{b}Mn_{c})D_{d}O₂

| | Example | | | | | |
|---|---|---|---|---|---|---|
| | Comp. | According to invention | | | | |
| | 1 | 2 | 3 | 4 | 5 | 6 |
| x | 0.2 | 0.2 | 0.2 | 0.2 | 0.2 | 0.2 |
| a | 0.13 | 0.13 | 0.16 | 0.13 | 0.16 | 0.16 |
| b | 0.13 | 0.13 | 0.08 | 0.13 | 0.08 | 0 |
| c | 0.54 | 0.54 | 0.56 | 0.54 | 0.56 | 0.56 |
| D | — | — | — | — | — | Al |
| d | — | — | — | — | — | 0.08 |

Flame spray pyrolysis

| | | | | | | | |
|---|---|---|---|---|---|---|---|
| Solution | | | | | | | |
| Lithium nitrate | % by wt. | 14.86 | 14.86 | 14.86 | 14.86 | 14.86 | 15.71 |
| Nickel (II) nitrate | % by wt. | 4.09 | 4.09 | 4.09 | 4.09 | 4.09 | 5.54 |
| Manganese (II) nitrate | % by wt. | 16.64 | 16.64 | 16.64 | 16.64 | 16.64 | 19.02 |
| Cobalt (II) nitrate | % by wt. | 4.10 | 4.10 | 4.10 | 4.10 | 4.10 | 0 |
| Aluminium nitrate | % by wt. | 0 | 0 | 0 | 0 | 0 | 3.23 |
| Total metal | % by wt. | 9.25 | 9.25 | 9.25 | 9.25 | 9.25 | 9.56 |
| Throughput | kg/h | 7 | 8 | 9 | 6 | 5 | 8 |
| Atomization air | m³ | 13 | 14 | 17 | 12 | 13 | 17 |
| | (STP)/h | | | | | | |
| Ammonia | kg/h | — | 1.14 | 1.14 | 1.14 | 1.14 | 0.76 |
| Ammonia/metal | kg/kg | 0 | 1.54 | 1.37 | 2.05 | 2.46 | 0.99 |
| Hydrogen | m³ | 15 | 15 | 10 | 13 | 15 | 11 |
| | (STP)/h | | | | | | |
| Air | m³ | 75 | 75 | 80 | 85 | 75 | 75 |
| | (STP)/h | | | | | | |
| Lambda | | 2.10 | 2.10 | 3.36 | 2.75 | 2.10 | 2.86 |
| Vₐₑᵣₒₛₒₗ | Nm/s | 134 | 134 | 119 | 93 | 87 | 87 |
| V_{flame} | Nm/s | 14.6 | 15.7 | 15.7 | 16.2 | 15.7 | 15.0 |
| Vₐₑᵣₒₛₒₗ/V_{flame} | | 9.18 | 8.54 | 7.58 | 5.74 | 5.54 | 4.27 |
| T_{flame}^{a)} | ° C. | 783 | 808 | 511 | 947 | 1086 | 680 |
| BET^{b)}_{FSP} | m²/g | 39 | 13 | 31 | 38 | 34 | 27 |

Heat treatment

| | | | | | | | |
|---|---|---|---|---|---|---|---|
| T_{furnace} | ° C. | 930 | 960 | 930 | 875 | 900 | 960 |
| t_{heating} | h | 6 | 6 | 6 | 6 | 6 | 6 |
| BETₜₑₘₚ | m²/g | 6.76 | 3.41 | 7.26 | 8.75 | 8.33 | 4.10 |
| H^{b)} | % by wt. | 0.016 | 0.035 | 0.059 | 0.088 | 0.077 | 0.058 |
| N^{b)} | % by wt. | 0.010 | 0.030 | 0.009 | 0.027 | 0.004 | 0.002 |
| C/10 (2nd cycle) | mAh/g | 202 | 246 | 240 | 253 | 241 | 173 |
| C/10 (60th cycle) | mAh/g | 172 | 222 | 224 | 233 | 219 | 177 |
| C10 | % | 85.1 | 90.2 | 93.3 | 92.1 | 90.9 | 102.3 |
| (60th cyc./2nd cyc.) | | | | | | | |
| C3 | mAh/g | 151 | 207 | 206 | 194 | 204 | 130 |
| 1C | mAh/g | 111 | 142 | 161 | 143 | 157 | 103 |
| 1st eff. | % | 60 | 74 | 72 | 79.8 | 73 | 64 |
| Fading 1C | mAhg⁻¹/Z | 0.136 | 0.096 | 0.078 | 0.037 | 0.082 | 0.150 |

^{a)}flame temperature; measured 10 cm below the feed point of hydrogen and air into the reaction space;
^{b)}after heat treatment

TABLE 2
Homogeneity of the cathode material (at % normalized to 100)

| | Example | | | | | |
|---|---|---|---|---|---|---|
| | 1 (comparison) | | | 2 (according to invention) | | |
| Image | Mn | Co | Ni | Mn | Co | Ni |
| 1 | 66.7 | 16.7 | 16.7 | 68.6 | 17.1 | 15.3 |
| 2 | 64.3 | 17.9 | 17.9 | 65.6 | 15.6 | 16.8 |
| 3 | 70.4 | 14.8 | 14.8 | 68.0 | 16.0 | 16.0 |
| 4 | 68.0 | 16.0 | 16.0 | 70.4 | 14.8 | 15.8 |
| 5 | 70.4 | 14.8 | 14.8 | 65.7 | 20.0 | 15.3 |
| 6 | 71.0 | 16.1 | 12.9 | 64.9 | 18.9 | 16.2 |
| 7 | 72.0 | 16.0 | 12.0 | 66.7 | 17.9 | 15.4 |
| 8 | 75.0 | 12.5 | 12.5 | 66.7 | 18.5 | 14.8 |
| 9 | 35.0 | 30.0 | 35.0 | 67.9 | 17.9 | 15.3 |
| 10 | 52.2 | 18.9 | 18.9 | 69.2 | 15.4 | 15.4 |
| 11 | 44.2 | 27.9 | 27.9 | 66.7 | 18.5 | 15.8 |
| 12 | 58.8 | 20.6 | 20.6 | 70.4 | 14.8 | 14.8 |
| 13 | 71.0 | 16.1 | 12.9 | 63.0 | 18.5 | 18.5 |
| 14 | 66.7 | 16.7 | 16.7 | 66.7 | 16.7 | 16.7 |
| 15 | 54.1 | 14.8 | 11.1 | 70.0 | 16.7 | 16.3 |
| 16 | 65.6 | 21.9 | 12.5 | 68.0 | 16.0 | 16.0 |
| 17 | 65.4 | 17.3 | 17.3 | 69.0 | 17.2 | 15.8 |
| 18 | 69.2 | 15.4 | 15.4 | 71.9 | 15.6 | 15.5 |
| σ_{(EDX)} | 10.0 | 4.3 | 5.7 | 2.1 | 1.4 | 0.8 |
| m_{avg(EDX)} | 63.3 | 18.0 | 17.0 | 67.7 | 17.0 | 15.9 |
| m_{avg(ICP)} | 66.8 | 17.1 | 16.1 | 66.8 | 17.1 | 16.1 |
| m_{avg(EDX)/} | 94.8 | 105.4 | 105.6 | 101.4 | 99.4 | 98.6 |
| m_{avg(ICP)} | | | | | | |

1. A process for producing a pulverulent cathode material, said cathode material comprising at least one mixed oxide containing metal component Li, at least one further metal component selected from the group consisting of Mn, Ni and Co,
said process comprising:
converting an ammonia-containing aerosol containing metal compound of the metal component in a high-temperature zone of a reaction space and
then removing the solids.

2. The process for producing the pulverulent cathode material according to claim 1, wherein
the aerosol is obtained by atomizing a solution containing the metal compounds by an atomization gas.

3. The process according to claim 1, wherein
the concentration of ammonia is 0.5-5.0 kg/kg of the sum total of the metals used, in kg/kg.

4. The process according to claim 1, wherein
the atomization is effected by means of a one-phase or multiphase nozzle and the mean droplet diameter of the aerosol is not more than 100 μm.

5. The process according to claim 1, wherein the high-temperature zone into which the aerosol is introduced is a flame which is formed by the reaction of an oxygen-containing gas and a combustion gas.

6. The process according to claim 5, wherein
the following applies to the ratio of mean velocity of the mixture to mean velocity of the flame: 2≦Vₐₑᵣₒₛₒₗ/V_{flame}≦10.

7. The process according to claim 1, wherein the solution contains at least one dopant compound containing a metal selected from the group consisting of Ag, Al, B, Ca, Cr, Cu, Fe, Ga, Ge, In, K, Mg, Mo, Na, Nb, Si, Sn, Ta, Ti, Tl, V and Zr.

8. The process according to claim 1, wherein at least one metal compound is a nitrate.

9. The process according to claim 1, wherein the solids removed are subjected to thermal treatment at temperatures of 850 to 1000° C. over a period of 2 to 36 h.

10. A pulverulent cathode material in the form of aggregated primary particles, comprising a mixed oxide powder having a composition corresponding to Li₁₊ₓ(NiₐCo_{b}Mn_{c})D_{d}O₂, and H and N as non-metal components, with a proportion of H of 0.01%-0.1% by weight and
a proportion of N of 0.002%-0.05% by weight, based in each case on the pulverulent cathode material, where D=Ag, Al, B, Ca, Cr, Cu, Fe, Ga, Ge, In, K, Mg, Mo, Na, Nb, Si, Sn, Ta, Ti, Tl, V and Zr, and 0<x≦0.2; 0<a≦1; 0≦b≦1; 0≦c≦1, 0≦d≦0.2.

11. The pulverulent cathode material in the form of aggregated primary particles according to claim 10, wherein
0<x≦0.2, 0.1≦a≦0.2; 0.05≦b≦0.2; 0.5<c≦0.6 and d=0.

12. The pulverulent cathode material in the form of aggregated primary particles according to claim 10, wherein
0<x≦0.2, 0<a≦1, b=0, 0.5<c≦0.6 and 0.05<d≦0.1.

13. The pulverulent cathode material in the form of aggregated primary particles according to claim 11, wherein
the mean relative concentration of the elements Ni, Mn and Co, which is determined by means of TEM-EDX from 18 randomly selected regions each comprising a volume of about 500 nm³ of the cathode material, does not deviate by more than 5% from the concentration of the pulverulent cathode material determined by means of ICP-OES, inductively coupled plasma optical emission spectrometry.

14. The pulverulent cathode material in the form of aggregated primary particles according to claim 11, wherein
the standard deviation in the relative concentration of the elements Ni, Mn and Co, which is determined by TEM-EDX from 18 randomly selected regions each comprising a volume of about 500 nm³ of the cathode material, is not more than 5% per element.

15. A lithium ion battery batteries, comprising:
the pulverulent cathode material according to claim 10.
